(19) United States
(12) Patent Application Publication
(10) Pub. No.: US 2022/0222351 A1
(43) Pub. Date: Jul. 14, 2022

(54) SYSTEM AND METHOD FOR SELECTION AND DISCOVERY OF VULNERABLE SOFTWARE PACKAGES

(71) Applicant: Twistlock, Ltd., Herzliya (IL)

(72) Inventors: Liron LEVIN, Herzliya (IL); Alon ADLER, Bat-Yam (IL); Michael KLETSELMAN, Tel Aviv (IL); Dima STOPEL, Herzliya (IL)

(73) Assignee: Twistlock, Ltd., Herzliya (IL)

(21) Appl. No.: 17/145,893

(22) Filed: Jan. 11, 2021

(51) Int. Cl. G06F 21/57; G06F 8/71

(52) U.S. Cl. CPC G06F 21/577; G06N 5/04; G06F 2221/033; G06F 8/71

(57) ABSTRACT

A system and method for discovering vulnerabilities in software packages. A method includes identifying at least one potential source of vulnerability in at least one potentially vulnerable software package of a plurality of software packages, wherein each potential source of vulnerability is a change to one of the at least one potentially vulnerable software package; and identifying at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

### TECHNICAL FIELD

The present disclosure relates generally to detecting software vulnerabilities, and more specifically to increasing vulnerability coverage in software vulnerability detection.

### BACKGROUND

As software-based technologies increasingly dominate daily life, detecting and fixing software vulnerabilities has become critical to ordinary functioning of systems. Some existing solutions utilize human operators trained to review software and processes using such software in order to identify potential vulnerabilities. These processes may involve manual review of code (e.g., by manually crawling software libraries in search of vulnerable software packages) or issues reported by users. However, these processes are highly inefficient as compared to automated solutions, are subject to human error, and often require subjective judgments on whether a vulnerability exists that yields inconsistent results.

Some automated solutions involving scanning for software vulnerabilities exist.

However, these solutions face significant challenges in accurately identifying software vulnerabilities. In particular, although some automated solutions can check for issues that are already known, these solutions have difficulty identifying previously unknown software, unknown versions of existing software, or software which otherwise lacks some form of standardized formatting. For operating system vulnerabilities, most major vendors provide a consistent and standard feed which can be utilized by existing solutions, but other software providers may not provide consistent and standard feeds. This can be particularly problematic for open source software packages or any other software which does not have a single source of truth.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for discovering vulnerabilities in software packages. The method comprises: identifying at least one potential source of vulnerability in at least one potentially vulnerable software package of a plurality of software packages, wherein each potential source of vulnerability is a change to one of the at least one potentially vulnerable software package; and identifying at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

Certain embodiments disclosed herein also include a non-transitory computer readable medium having stored thereon causing a processing circuitry to execute a process, the process comprising: identifying at least one potential source of vulnerability in at least one potentially vulnerable software package of a plurality of software packages, wherein each potential source of vulnerability is a change to one of the at least one potentially vulnerable software package; and identifying at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

Certain embodiments disclosed herein also include a system for discovering vulnerabilities in software packages. The system comprises: a processing circuitry; and a memory, the memory containing instructions that, when executed by the processing circuitry, configure the system to: identify at least one potential source of vulnerability in at least one potentially vulnerable software package of a plurality of software packages, wherein each potential source of vulnerability is a change to one of the at least one potentially vulnerable software package; and identify at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for discovering unknown software vulnerabilities in software packages according to an embodiment.

FIG. 3 is a flowchart illustrating a method for identifying potential sources of vulnerabilities according to an embodiment.

FIG. 4 is an example flowchart illustrating a method for mapping a software package to a standardized vulnerabilities identifier according to an embodiment

FIG. 5 is a schematic diagram of a vulnerability detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for detecting software vulnerabilities. One or more repositories may be selected for analysis. Each repository stores software packages. One or more potential sources of vulnerability are selected for analysis from among changes to software packages in the selected repositories based on data related to the software packages. The potential sources of vulnerabilities are identified using rules that may be based on factors such as, but not limited to, frequency of use, date of creation, whether the software package is known as being open source, combinations thereof, and the like.

In an embodiment, identifying the potential sources of vulnerabilities may include any or all of querying and parsing change instructions, tracking specific developers, analyzing code comments, analyzing release notes, and inferring potential vulnerabilities based on version identifiers. Each change instruction is an instruction to change a portion of data and therefore represents a change being finalized or confirmed. The change instructions may include, but are not limited to, commit statements (also referred to herein as “commits”).

Based on the results of these steps, security-related changes to software packages which are potential sources of vulnerabilities are identified. Unique identifiers may be created for the security-related changes. The unique identifiers may be utilized to anonymize the changes while allowing for looking up specific changes that caused vulnerabilities later. Such anonymization of changes may be important to preserving proprietary information.

Vulnerability identification rules are selected and applied to data of each of the security-related changes in order to identify any vulnerabilities caused by these changes and, therefore, identifying vulnerable software packages resulting from these changes. The vulnerability identification rules may be selected based on the availability of version identifiers for the software repository storing the software package. For example, a first rule may be selected when the software repository has package versions, a second rule may be selected when the repository has release versions but not package versions, and a third rule may be selected when the repository does not have any version identifiers for software packages. The different rules may define circumstances when a software package is considered to be vulnerable. Thus, applying such vulnerability identification rules allows for objectively determining whether a given software package is vulnerable.

Each software package having one of the identified vulnerabilities may be mapped to a known name of a standard software package naming scheme. Such a software package naming scheme may be, but is not limited to, Common Platform Enumeration (CPE). CPE is a structured naming scheme which can be utilized for software vulnerabilities. CPE utilizes a generic syntax for Uniform Resource Identifiers (URIs) and includes a formal name format, a method for checking names against a system, and a description format for binding text and tests to a name. CPE also utilizes a dictionary defining an agreed upon list of names for CPE.

Each software package having one of the identified vulnerabilities may further be mapped to a standardized software vulnerabilities identifier such as, for example, an identifier defined per Common Vulnerabilities and Exposures (CVE). The mapping of software packages to standardized software vulnerability identifiers may be based on the mapping of the software package to the name of the standard software package naming scheme.

In some embodiments, a dependencies graph may be created or updated based on the identified vulnerabilities. The dependencies graph includes nodes representing software packages connected by edges representing dependencies among software packages. The dependencies graph further includes metadata for nodes representing software packages that were identified as vulnerable. Consequently, such a dependencies graph allows for identifying vulnerabilities caused by dependencies among software packages. For example, a first software package which is not vulnerable by itself may be dependent on a second software package that is vulnerable such that a dependency of the first software package on the second software package may represent a vulnerability.

The disclosed embodiments provide an automated process for detecting software vulnerabilities that do not rely on manual evaluation of code or comments nor require rules created based on known vulnerabilities. The disclosed embodiments can be utilized to identify unknown vulnerabilities or vulnerabilities which are reported but do not explicitly match known vulnerabilities. The disclosed embodiments therefore allow for detecting more software vulnerabilities than existing automated solutions without requiring subjective analysis that can result in human error or inconsistent results.

Moreover, the disclosed embodiments can allow for detecting vulnerabilities before they are formally reported or even if the vulnerabilities are reported improperly. Further, the disclosed embodiments use vulnerability rules selected according to predetermined criteria which improves objectivity of vulnerability detection. Accordingly, the disclosed embodiments allow for improving accuracy of software vulnerability detection such that more software vulnerabilities are detected without significantly increasing the number of false positives.

Further, the disclosed embodiments allow for accurately matching vulnerable software packages that are not properly identified to known software packages. In this regard, it is noted that the standardized version of a software package name often does not match the actual name of the software package (for example, a name indicated in metadata of the software package). As a non-limiting example, the actual name of the package may be indicated as “org.apache.httpcomponents)_httpclient” while the CPE name for the package may be “apache:httpclient.” Existing automated solutions cannot map the package to its respective standardized name and, accordingly, often fail to accurately identify changes to a particular software package when the changes come from different sources.

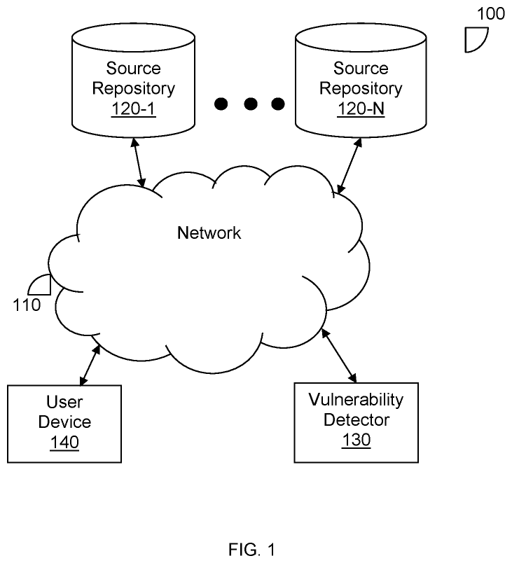

FIG. 1 shows an example network diagram 100 utilized to describe the various disclosed embodiments. In the example network diagram 100, source repositories 120-1 through 120-N (hereinafter referred to individually as a source repository 120 and collectively as source repositories 120, merely for simplicity purposes), a vulnerability detector 130, and a user device 140 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

Each of the source repositories 120 stores software packages (not shown) which may be vulnerable. At least some of the source repositories 120 may be open source repositories storing open source software packages. Open source software packages do not use standardized formatting therefore may not allow for ready identification of known software vulnerabilities using predetermined rules associated with different formats of software packages. To this end, the vulnerability identifier 130 is configured to identify software vulnerabilities as described herein. Such vulnerability identification allows for identifying unknown or otherwise improperly reported vulnerabilities, and can identify those vulnerabilities in open source software packages or other software packages lacking known formatting.

The user device (UD) 140 may be, but is not limited to, a personal computer, a laptop, a tablet computer, a smartphone, a wearable computing device, or any other device capable of receiving and displaying notifications.

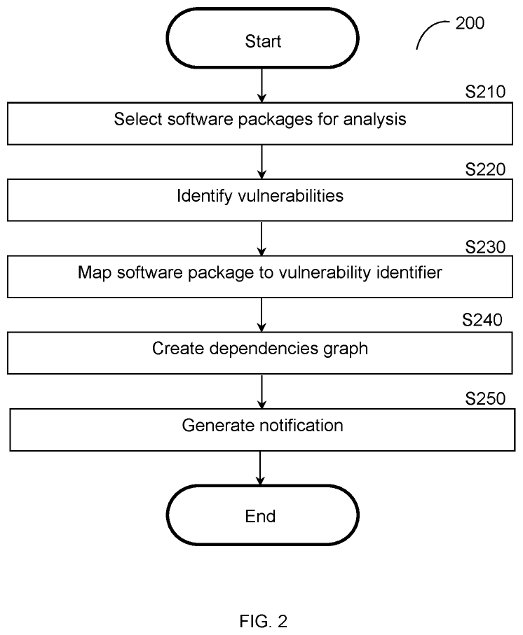

FIG. 2 is a flowchart 200 illustrating a method for discovering unknown software vulnerabilities in software packages according to an embodiment. In an embodiment, the method is performed by the vulnerability detector 130, FIG. 1.

At S210, potential sources of vulnerabilities to be analyzed are identified. In an embodiment, S210 includes analyzing various data related to software packages in order to identify certain changes as potentially causing vulnerabilities. In this regard, it is noted that the number of changes to software packages grows exponentially over time such that analyzing each and every change for vulnerabilities is impractical even for automated solutions. By selectively analyzing changes as described herein, the disclosed embodiments allow for reducing excessive computing resource consumption needed for analyzing software packages subject to those changes while still identifying most, if not all, undiscovered vulnerabilities.

In a further embodiment, S210 may also include selecting repositories for which software packages are to be analyzed. Selecting specific repositories allows for further reducing the scope of data that must be analyzed, thereby further reducing consumption of computing resources related to analysis.

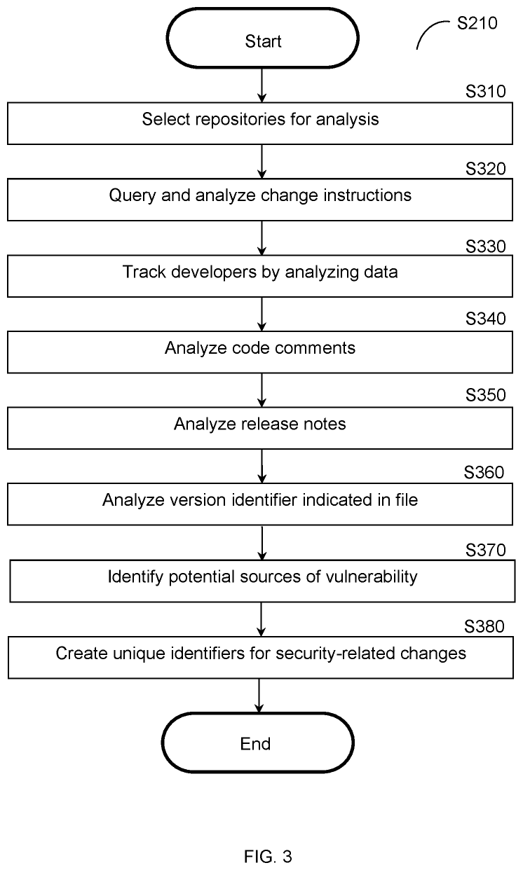

In an embodiment, identification of potential sources of vulnerabilities is performed according to the flowchart depicted in FIG. 3. FIG. 3 is a flowchart S210 illustrating a method for identifying potential sources of vulnerabilities according to an embodiment.

At optional S310, repositories are selected for analysis. The repositories are selected for analysis such that the analyzed repositories are more likely to have unknown or otherwise undiscovered vulnerable software packages. For example, open-source software repositories are more likely to include unknown software packages than software repositories of major software developers. As another example, repositories having more frequently accessed or updated software packages may be more important to analyze for new and emerging vulnerabilities.

Selecting repositories for analysis based on likelihood of having unknown or undiscovered software packages reduces use of computing resources required for such analysis. In this regard, it is noted that the total number of potential repositories is large and that, even for automated systems, analyzing all of those repositories for vulnerabilities is impractical. Thus, the disclosed embodiments reduce the amount of data needing to be scanned and, therefore, improve the efficiency of analysis.

In an embodiment, the repositories are selected based on the relative amount of use of software packages stored in each repository as compared to that of other repositories. In a further embodiment, the repositories are selected based on a feedback loop of user data, inferred popular repositories, package download statistics, or a combination thereof.

The user data is analyzed through a feedback loop to determine which packages are being used more frequently and, accordingly, which repositories include frequently used packages. A software package may be used frequently if, for example, the number of downloads of the software package within a certain time period (e.g., the past week) is above a threshold. A repository may be selected based on frequency of package use based on, for example, having one or more frequently used software packages, having a number of frequently used software packages above a threshold, being among a threshold number of repositories having the highest number of frequently used software packages (e.g., the top 10 repositories having the most frequently used software packages), and the like.

Inferring popular repositories may be accomplished by using an application programming interface (API) to recursively crawl repositories for package dependency manifests and determining which packages are most often depended upon by other packages. A software package may be popular if, for example, the number of dependencies of other software packages on that software package is above a threshold. A repository may be selected based on package popularity based on, for example, having one or more popular software packages, having a number of popular software packages above a threshold, being among a threshold number of repositories having the highest number of popular software packages, and the like.

The package download statistics may be obtained, for example, but querying a package manager API. Repositories having the most downloaded software packages may be selected.

At steps S320 through S360, various portions of data indicating changes which may be sources of vulnerabilities are analyzed in order to identify security-related changes. The security-related changes may be reflected, for example, in change instructions, comments, notes, or other data related to a software package as described further below with respect to steps S320 through S360.

It should be noted that the steps of steps S320 through S360 may be performed in any order or in parallel, and that only a portion of those steps may be performed in at least some embodiments. When repositories are selected as described above with respect to S310, only software packages in the selected repositories are analyzed.

At S320, change instruction messages are obtained via query and analyzed. The change instructions may be, for example, commits. To this end, S320 may include querying change instruction messages and analyzing the messages based on keywords included therein. In a further embodiment, S320 further includes applying a machine learning model trained to identify security-related keywords based on historical change instruction messages. Such a model may be further trained for text classification. Change instructions which include security-related keywords are identified as potential sources of vulnerabilities.

At S330, data related to each software package is analyzed to track predetermined developers indicated therein. The developers may be security researchers or software developers, and may be developers known as owning security for certain software packages such that commits from those developers are more likely to be associated with potentially unknown security fixes. To this end, when such predetermined suspect developers are identified for a software package, changes by those developers are identified as potential sources of vulnerabilities.

At S340, code comments for each software package are analyzed for security-related keywords. In an embodiment, S340 further includes applying a machine learning model trained to identify security-related keywords based on historical code comments. Such a model may be further trained for text classification. Changes indicated by comments including security-related keywords are identified as potential sources of vulnerabilities.

At S350, release notes for each software package are analyzed for a date of release. Changes that added or modified newer software packages (e.g., software packages that were released less than a threshold period of time prior to a current time) are identified as potential sources of vulnerabilities.

At S360, a version indicator in a file of each software package is analyzed to infer changes to files related to the software package which may be potential sources of vulnerabilities. In an example implementation, the version indicator may be included in a manifest file such that a change to the manifest file after a change which updated the software package to its current version identifier would be identified as a potential source of vulnerability. To this end, S360 may further include analyzing change instructions to determine whether any change instruction occurred after the change instruction which updated the software package to its current version.

At S370, based on the analyses performed at S320 through S360, one or more potential sources of vulnerability are identified as described above with respect to these steps.

At optional S380, unique identifiers may be created and assigned to respective vulnerability-related changes among the identified vulnerability-related changes. The changes may be changes made permanent by change instructions, indicated in code comments, indicated in release notes, and the like. The unique identifiers may be utilized to allow for looking up specific changes that caused vulnerabilities later, and may further allow for anonymizing the changes. Such anonymization of changes may be important to preserving proprietary information.

Returning to FIG. 2, at S220, vulnerabilities are identified. The identified vulnerabilities may be unknown, improperly reported, or otherwise undiscovered vulnerabilities. Identifying such vulnerabilities also results in identifying vulnerable software packages.

In an embodiment, S220 includes selecting and applying vulnerability identification rules based on data related to each software package which was subject to a change which is a potential source of vulnerability that was identified at S210. In a further embodiment, the vulnerability identification rules are selected based on the availability of version identifiers for the software repository storing the software package. In yet a further embodiment, a first rule is selected when the software repository storing the software package has package versions or otherwise when a package version is available for the software package, a second rule is selected when the repository for the software package has release versions but not package versions or otherwise when a release version is available but a package version is not, and a third rule is selected when the repository for the software package does not have any version identifiers for software packages or otherwise neither a package version nor a release version is available for the software package.

In an embodiment, the first rule defines a vulnerable software package as a software package having a package version that is an earlier or same version as the version indicated in the latest change instruction (e.g., the latest commit). The second rule defines a vulnerable software package as a software package having a release version that is not temporally correlated with a change instruction (e.g., a release version associated with a date of release that is not within a threshold number of days of a date indicated by a timestamp of a most recent commit for the software package). The date of release of a release version may be stored in publicly available repositories. The third rule defines a vulnerable software package as a software package that is not temporally correlated with a release time indicated in data stored in public repositories (e.g., a software package having data indicating a time of creation that is not within a threshold time of a most recent change indicated by a package manager such as Node Package Manager (NPM)).

At S230, each vulnerable software package (i.e., each vulnerable software package having an identified vulnerability) is mapped to a respective vulnerability identifier. In an embodiment, S230 includes mapping each identified vulnerable software package to a standardized name of a standard software package naming scheme and mapping each identified vulnerable software package to a standardized software vulnerabilities identifier based on the standardized name for each identified vulnerable software package.

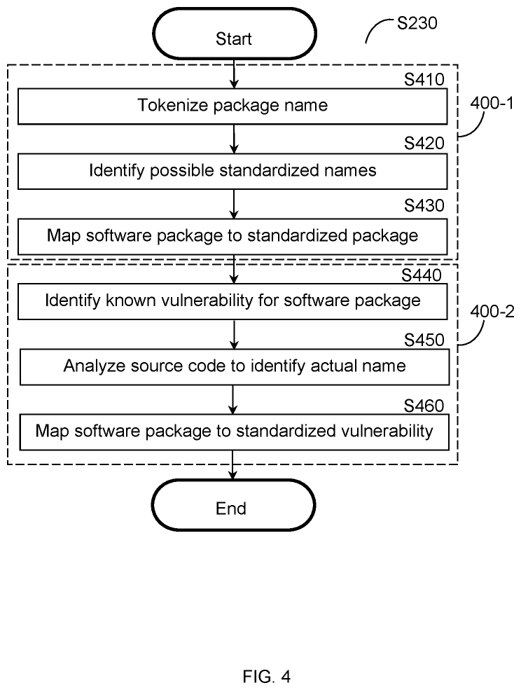

In an embodiment, each vulnerable software packages is mapped to a respective vulnerability identifier using the process according to FIG. 4. FIG. 4 is an example flowchart S230 illustrating a method for mapping a software package to a standardized vulnerabilities identifier according to an embodiment.

In an embodiment, the process depicted in FIG. 4 further includes two sub-processes 400-1 and 400-2. In the first sub-process, the software package is mapped to a standardized software package name such that it can be accurately identified using that mapping. In the second sub-process, the software package is mapped to a standardized vulnerability identifier such that a known type of vulnerability can be identified for the software package. In other embodiments, the method of FIG. 4 may include only the second sub-process 400-2.

In the first sub-process 400-1, at S410, a package name indicated in data of the software package is tokenized.

At S420, one or more possible standardized software package names for the software package are identified in one or more software package repositories. In an embodiment, S420 may include querying a package manager or other program configured to search through one or more software package repositories storing data indicating names of software packages in a standardized naming scheme such as Common Platform Enumeration (CPE). The querying may utilize the tokenized name of the software package.

At S430, the software package is mapped to a standardized software package name based on results returned from querying the software package repositories. In an embodiment, S430 includes tokenizing the possible standardized software package names identified at S420 and comparing the tokenized name of the software package to each tokenized possible standardized software package name. In a further embodiment, a score representing a degree of similarity between each pair of tokenized names may be generated, and the standardized software package name having the highest score with the name of the software package is determined as the appropriate mapping. In yet a further embodiment, only a standardized software package name having a score above a threshold may be determined as the appropriate mapping.

In the second sub-process 400-2, at S440, based on a known package name of the software package, a known vulnerability for the software package is identified. The known vulnerability has an identifier in a standardized vulnerability identifier format and may be identified by analyzing a change instruction history for the software package. Such a standardized format may be, for example, Common Vulnerabilities and Exposures (CVE).

At S450, the source code of the software package is analyzed to identify the actual name of the software package indicated in the data of the software package.

At S460, based on the known vulnerability identified at S440 and the actual name identified at S450, a mapping between the software package and the standardized vulnerability identifier is created. In an embodiment, the mapping may be extracted from a standards database such as, but not limited to, the National Vulnerabilities Database (NVD).

Returning to FIG. 2, at optional S240, a dependencies graph may be created or updated based on the identified vulnerable software packages. The dependencies graph defines dependencies among software packages, and is created or updated to include the identified vulnerable software packages. Accordingly, the dependencies graph demonstrates dependencies on vulnerable software packages by otherwise non-vulnerable software packages. Such dependencies on vulnerable software packages may make those otherwise non-vulnerable software packages more susceptible to issues such that they can also be considered vulnerable. As a result, the dependencies graph demonstrates these indirect vulnerabilities, i.e., vulnerabilities which cannot be identified by analyzing the code of the software package itself but are instead inherited by virtue of depending upon a vulnerable software package.

At S250, a notification is generated based on the identified vulnerable software packages. The notification may indicate, but is not limited to, the identified vulnerable software packages, the dependencies graph, both, and the like.

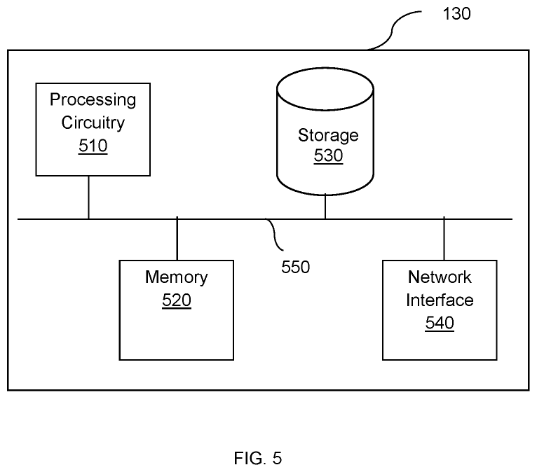

FIG. 5 is an example schematic diagram of a vulnerability detector 130 according to an embodiment. The vulnerability detector 130 includes a processing circuitry 510 coupled to a memory 520, a storage 530, and a network interface 540. In an embodiment, the components of the vulnerability detector 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the vulnerability detector 130 to communicate with, for example, the source repositories 120, the user device 140, or both.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for discovering vulnerabilities in software packages, comprising:
identifying at least one potential source of vulnerability in at least one potentially vulnerable software package of a plurality of software packages, wherein each potential source of vulnerability is a change to one of the at least one potentially vulnerable software package; and
identifying at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

2. The method of claim 1, wherein the selected at least one vulnerability identification rule for a software package is a first rule when a package version is available for the software package, wherein the first rule defines a vulnerability as the software package having a package version that is an earlier or same version as a version indicated in a most recent change instruction for the software package.

3. The method of claim 2, wherein the selected at least one vulnerability identification rule for a software package is a second rule when a release version is available for the software package but a package version is not available for the software package, wherein the second rule defines a vulnerability as the software package having a release version that is not within a threshold period of time of a most recent change instruction for the software package.

4. The method of claim 3, wherein the selected at least one vulnerability identification rule for a software package is a third rule when neither a package version nor a release version is not available for the software package, wherein the third rule defines a vulnerability as the software package having a time of creation that is not within a threshold period of time of a most recent change indicated by a package manager for the software package.

5. The method of claim 1, wherein identifying the at least one potential source of vulnerability further comprises at least one of: analyzing change instruction messages, tracking at least one predetermined message, analyzing code comments for security-related keywords, analyzing release notes for dates of release, and inferring vulnerabilities based on changes to files occurring after changes updating version indicators.

6. The method of claim 1, further comprising:
selecting at least one software package repository from among a plurality of software package repositories based on a relative amount of use of software packages stored in each of the plurality of software package repositories as compared to software packages stored in each other software repository of the plurality of software package repositories, wherein the plurality of software packages is stored in the selected at least one software package repository.

7. The method of claim 6, wherein selecting the at least one software package repository from among the plurality of software package repositories further comprises:
analyzing user data to determine frequency of software package use for each of the plurality of software package repositories, wherein each of the at least one software package repository has a highest frequency of software package use among the plurality of software package repositories.

8. The method of claim 6, wherein selecting the at least one software package repository from among the plurality of software package repositories further comprises:
recursively crawling the plurality of software package repositories for package dependency manifests; and
determining, for each of the plurality of software package repositories, the relative amount of use of the software package repository based on a number of software packages which depend from each software package stored in the software package repository.

9. The method of claim 1, wherein the at least one identified vulnerability is associated with at least one vulnerable software package among the plurality of software packages, further comprising:
generating a dependencies graph based on the identified at least one vulnerability, wherein the dependencies graph indicates a plurality of dependencies between software packages, wherein the plurality of dependencies includes at least one dependency on the at least one vulnerable software package.

10. A non-transitory computer readable medium having stored thereon instructions for causing a processing circuitry to execute a process, the process comprising:
identifying at least one potential source of vulnerability in at least one potentially vulnerable software package of a plurality of software packages, wherein each potential source of vulnerability is a change to one of the at least one potentially vulnerable software package; and
identifying at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

11. A system for discovering vulnerabilities in software packages, comprising:
a processing circuitry; and
a memory, the memory containing instructions that, when executed by the processing circuitry, configure the system to:
identify at least one potential source of vulnerability in at least one potentially vulnerable software package of a plurality of software packages, wherein each potential source of vulnerability is a change to one of the at least one potentially vulnerable software package; and
identify at least one vulnerability in the plurality of software packages by selecting and applying at least one vulnerability identification rule to data of each of the at least one potentially vulnerable software package, wherein the at least one vulnerability identification rule for each of the at least one potentially vulnerable software package is selected based on an availability of version identifiers for the potentially vulnerable software package.

12. The system of claim 11, wherein the selected at least one vulnerability identification rule for a software package is a first rule when a package version is available for the software package, wherein the first rule defines a vulnerability as the software package having a package version that is an earlier or same version as a version indicated in a most recent change instruction for the software package.

13. The system of claim 12, wherein the selected at least one vulnerability identification rule for a software package is a second rule when a release version is available for the software package but a package version is not available for the software package, wherein the second rule defines a vulnerability as the software package having a release version that is not within a threshold period of time of a most recent change instruction for the software package.

14. The system of claim 13, wherein the selected at least one vulnerability identification rule for a software package is a third rule when neither a package version nor a release version is not available for the software package, wherein the third rule defines a vulnerability as the software package having a time of creation that is not within a threshold period of time of a most recent change indicated by a package manager for the software package.

15. The system of claim 11, wherein the system is further configured to perform at least one of: analyze change instruction messages, track at least one predetermined message, analyze code comments for security-related keywords, analyze release notes for dates of release, and infer vulnerabilities based on changes to files occurring after changes updating version indicators.

16. The system of claim 11, wherein the system is further configured to:
select at least one software package repository from among a plurality of software package repositories based on a relative amount of use of software packages stored in each of the plurality of software package repositories as compared to software packages stored in each other software repository of the plurality of software package repositories, wherein the plurality of software packages is stored in the selected at least one software package repository.

17. The system of claim 16, wherein the system is further configured to:
analyze user data to determine frequency of software package use for each of the plurality of software package repositories, wherein each of the at least one software package repository has a highest frequency of software package use among the plurality of software package repositories.

18. The system of claim 16, wherein the system is further configured to:
recursively crawl the plurality of software package repositories for package dependency manifests; and
determine, for each of the plurality of software package repositories, the relative amount of use of the software package repository based on a number of software packages which depend from each software package stored in the software package repository.

19. The system of claim 11, wherein the at least one identified vulnerability is associated with at least one vulnerable software package among the plurality of software packages, wherein the system is further configured to:
generate a dependencies graph based on the identified at least one vulnerability, wherein the dependencies graph indicates a plurality of dependencies between software packages, wherein the plurality of dependencies includes at least one dependency on the at least one vulnerable software package.
